(19) United States
(12) Patent Application Publication
(10) Pub. No.: US 2009/0094280 A1
(43) Pub. Date: Apr. 9, 2009

(54) METHOD OF COMBINING PERSONAL MEDIA FILES WITH A DIGITAL MAP

(75) Inventors: Ming-Hua CHEN, Sindian City (TW); Jiun-Yao HUANG, Sindian City (TW)

Correspondence Address: PATENTTM.US, P. O. BOX 82788, PORTLAND, OR, 97282-0788, US

(73) Assignee: MOBILE ACTION TECHNOLOGY INC., Sindian City (TW)

(21) Appl. No.: 11/869,106

(22) Filed: Oct. 9, 2007

(51) Int. Cl. G06F 7/00

(52) U.S. Cl. 707/104.1; 707/E17.005

(57) ABSTRACT

A method of combining personal media files with a digital map has (a) obtaining original information including a tracking information and multiple personal media files; (b) matching each media file to the corresponding tracking coordinates and recording matched points; (c) generating a displaying program codes to display a tracking pattern and media file on a browser; and (d) packing the matched media files, the tracking information and the generating the displaying program codes to HTML/MHTML format file. Therefore, the user generates the HTML/MHTML format file by the local computer and IE browser directly executes the HTML/MHTML format file to play the personal media files without other plug-in software.

### BACKGROUND OF THE INVENTION

1. Field of the Invention

The present invention relates to a method of combining digital information, and more particularly to a method of combining personal media files with a digital map.

2. Description of Related Art

In recent years, various electronic devices such as digital camera, portable computers have become necessary because people usually use the digital camera to record their life and generate digital media files. Then people review the media files by the computer.

Further, digital media files are easily to review and be stored in the computer. Since the Internet is popular, people like to apply for a web storage space in a web server and then upload all of personal media files to the web storage space. Some web servers also provide a web photo album, People can select parts of the media files stored in the web storage space to publish on the web photo album to share with other people and keep the private parts of the media files in the web storage space. Therefore, other people link to the web server to review the selected media files shown on the web photo album. However, the web photo album only provides media files to review, other people do not know more information about the owner's traveling life for example traveling scenic spots.

Since the personal media files are stored in the web server, the media file owner has to link to the web sever to manage the media files via the Internet and other people also have to link to the web server to review the media files via the Internet. Therefore, the linking quality of the Internet directly affects uploading and downing rates. In addition, some private media files stored in the web storage space are easily to be stolen by the hacker via the Internet. Thus, it is not safe to store private media files in the web storage space.

To overcome the shortcomings, the present invention provides a combining method to obviate or mitigate the aforementioned problems.

### SUMMARY OF THE INVENTION

The main objective of the invention is to provide method of combining personal media files with a digital map.

To accomplish the foregoing objective, the combining method has:

(a) obtaining original information including a tracking information and multiple personal media files;

(b) matching each media file to the corresponding tracking coordinates and recording matched points;
(c) generating a displaying program codes to display a tracking pattern and media file on a browser; and
(d) packing the matched media files, the tracking information arid the generating the displaying program codes to HTML/MHTML format file.

Based on the foregoing description, a user selects parts of the personal medial files to generate the HTML/MHTML format file by the local computer, not remote web server. In addition, the HTML/MHTML format file is easily to send to the other's computer. When the HTML/MHTML format file is received, the IE browser directly executes the HTML/MHTML format file to play the personal media files without other plug-in software. The user does not upload personal media files to the web server and easily share the media files with others.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a first embodiment of a combining method in accordance with the present invention; and

FIG. 2 is a flow chart of a second embodiment of a combining method in accordance with the present invention;

FIG. 3 is a table showing matched points of personal media files and a tracking information; and

FIGS. 4A and 4B are schematic views of showing HTML or MHTML file generated by the present invention.

### DETAILED DESCRIPTION OF THE PREFERRED EMBODIMENT

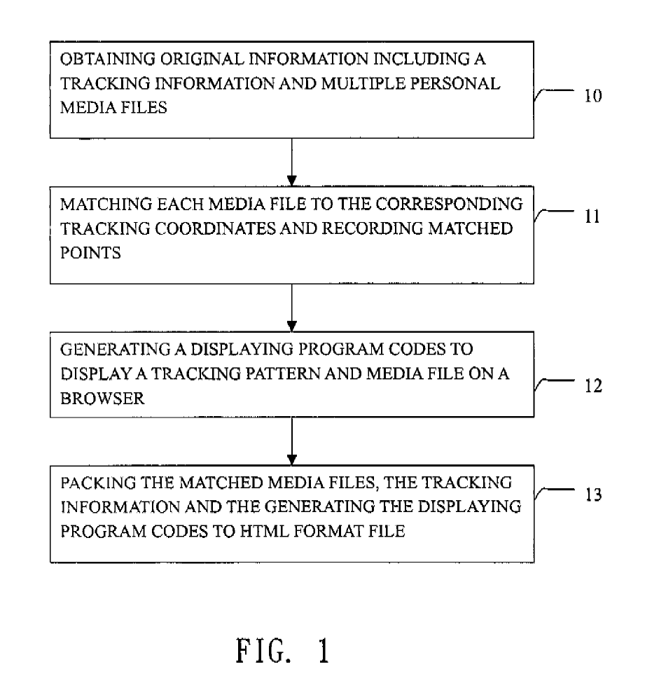

With reference to FIG. 1, a first embodiment of a combining method in accordance with the present invention has steps of:

obtaining personal original information having a tracking information and multiple personal media files wherein the tracking information has multiple tracking coordinates and multiple dates corresponding to the tracking coordinates, and the each personal media file stores a building date (10) or building coordinates, for example photographing location coordinates;

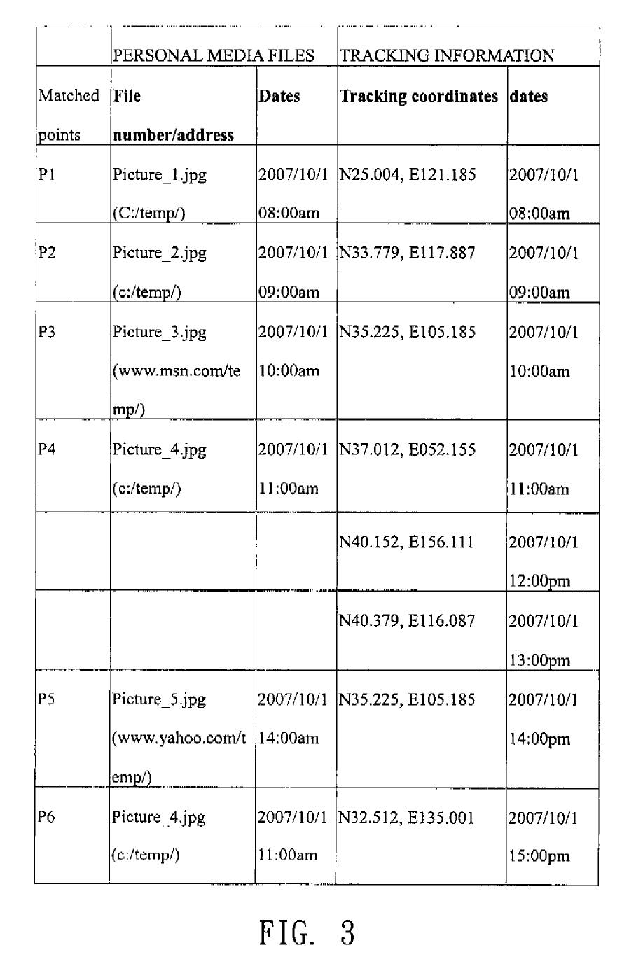

matching each personal media file to the corresponding tracking coordinate of the tracking information and recording matched points (11), wherein the matched points are determined by matching the building date of each media file to the dates of the tracking coordinates or by matching the building corresponding of each media file to the tracking coordinates, wherein an user interface is provided to allow the user to adjust each media file to match one tracking coordinate to slightly change matched pointed, with reference to FIG. 3, there are 6 matched points;

generating a displaying program codes used to display a tracking pattern and media file on a browser (12); and

packing the matched media files, the tracking information and the generating the displaying program codes to HTML format file (13).

Since the dates of the tracking coordinates or tracking coordinates are not equal to the building dates or the building coordinates of the personal media files, each of the foregoing ways of determining matched points may be a fuzzy matching way. That is, when the building date or building coordinate of each media file is not equal to corresponding date of the tracking coordinates or corresponding tracking coordinate, the match step will automatically select to a closest date or a closest coordinate to match to the media file.

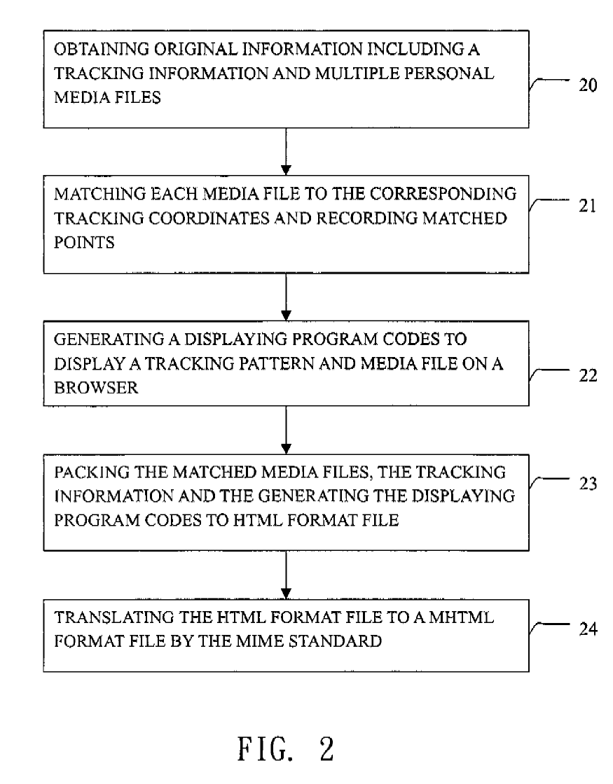

With further reference to FIG. 2, a second of a combining method in accordance with the present invention has steps of:

obtaining personal original information having a tracking information and multiple media files, wherein the tracking information has multiple tracking coordinates and multiple dates corresponding to the tracking coordinates, and the each media file stores a building date (20);

matching the building date of each media file to the dates of the tracking coordinates and recording matched points (21), wherein an user interface is provided to allow the user to adjust each media file to match one tracking coordinate;

generating a displaying program codes used to display a tracking pattern and media file on a browser (22);

packing the matched media files, the tracking information and the generating the displaying program codes to HTML format file (23); and

translating the HTML format file to an MHTML (Multipurpose Internet Mail Extension HTML) format file (xxx.mht) by MIME (Multipurpose Internet Mail Extensions) translation standard (24). Therefore, the second embodiment of the present invention only generates one computer file (xxx.mht) without other attached personal.

The foregoing generating step of the first and second embodiments has detailed acts of:

generating drawing route program codes according to the matched tracking coordinates and addresses of each media file in a computer;

generating displaying marker pattern program codes to show the matched points;

generating playing dynamic route program codes by JavaScript language; and

generating a digital map resource to show a digital map on which a route according to the tracking information is marked. The digital map resource may be an address of the local computer or a URL address for a web server in which the digital map is stored. For example, a URL address of the Google Map is generated and packaged in the HTML or MHTML file.

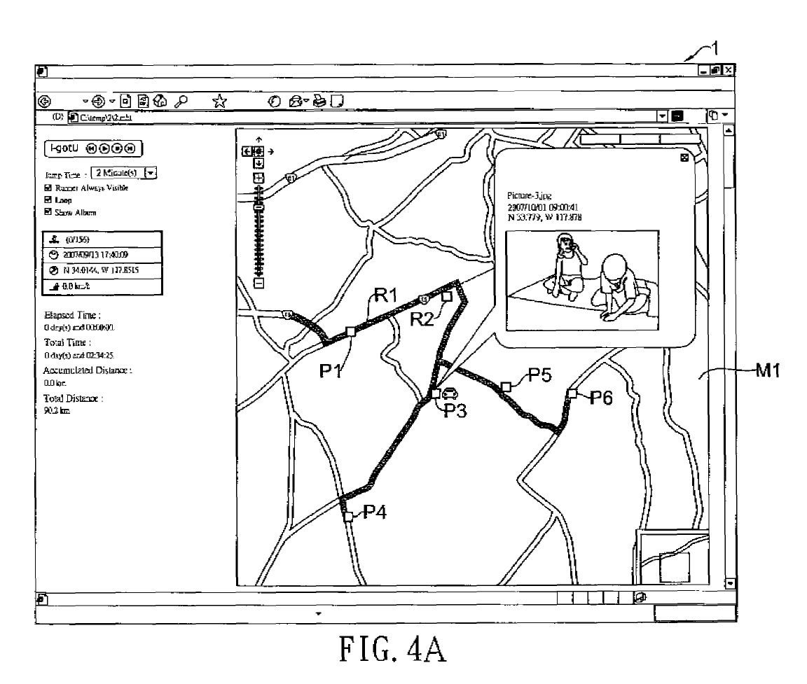

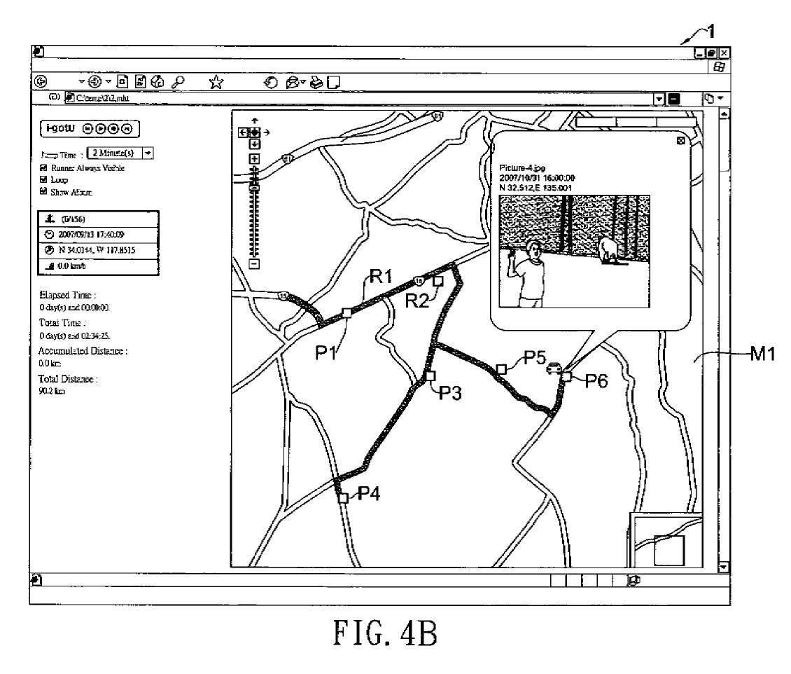

When a user generates an HTML or MHTML files according to the present invention, the HTML file or MHTML file is easily shared with others. Since personal computer or portable computer has IE browser to execute the HTML or MHTML file, the user can e-mail the HTML file with the media files or the MHTML file to friend's computer. The friend only clicks the HTML file or MHTML file, the IE browser executes automatically the HTML file and MHTML file. With reference to FIGS. 4A and 4B the IE browser (1) links to the URL address of the digital map and then downloads the digital map to show the digital map and a route (R1) on the digital map (M1). The rote (R1) is marked on the digital map (M1) by different color according to the tracking coordinates of the tracking information. Since the matched points are packaged in the HTML file or MHTML file, the marker patterns (P1 to P6) corresponding to the matched points are marked on the route (R1). When the IE browser (1) executes the playing dynamic route program codes, the media files are displayed in sequence. In FIG. 4A, a third marker pattern (P3) is automatically clicked, so the third media file (Picture_{—}3.jpg) corresponding to the first marker pattern (P3) is displayed. When the third marker pattern (P3) is not clicked anymore, the third media file media file (Picture_{—}3.jpg) is not shown on the IE browser. In FIG. 4B, when the sixth media file (Picture_{—}6.jpg) corresponding to the sixth marker pattern (P6) is clicked automatically, the sixth media file (P6) is played to display.

Based on the foregoing description, the personal media files (Picture_{—}1.jpg to Picture_{—}6.jpg) are displayed dynamically by executing the IE browser (1), so it is not necessary to install other software to display the digital map combined with the personal media files. Therefore, the user can generate the HTML file or MHTML file including user's personal media and travel tracking information by the local computer. Then, the user can send the HTML file or MHTML file to the user's friend by e-mail or Internet communication tools. When the HTML/MHTML format file is received, the IE browser directly executes the HTML/MHTML format file to play the personal media files without other plug-in software. The user does not upload personal media files to the web server and easily share the media files with others.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A method of combining personal media files with a digital map, comprising steps of:
obtaining original information comprising a tracing information consisted of multiple tracking coordinates, and multiple personal media files;
matching each personal media file to the corresponding tracking coordinate of the tracking information and recording matched points;
generating a displaying program codes to display a tracking pattern and media file on a browser; and
packing the matched media files, the tracking information and the generating the displaying program codes to HTML format file.

2. The combining method as claimed in claim 1, further comprising a MIME translation step after packing step to translate the HTML format file to an MHTML format file.

3. The combining method as claimed in claim 1, wherein the generating step has acts of:
generating drawing route program codes according to the matched tracking coordinates and addresses of each media file in a computer;
generating displaying marker pattern program codes to point the matched points; and
generating playing dynamic route program codes.

4. The combining method as claimed in claim 2, wherein the generating step has acts of:
generating drawing route program codes according to the matched tracking coordinates and addresses of each media file in a computer;
generating displaying marker pattern program codes to point the matched points; and
generating playing dynamic route program codes.

5. The combining method as claimed in claim 1, wherein the tracking information comprises:
a tracking information having multiple tracking coordinates and dates corresponding to the tracking coordinates; and
multiple personal media files, each of stores a building date; and
in the matching step, the matched point is determined by matching the building date of each media file to the dates of the tracking coordinates.

6. The combining method as claimed in claim 2, wherein the tracking information comprises:
a tracking information having multiple tracking coordinates and dates corresponding to the tracking coordinates; and
multiple personal media files, each of stores a building date; and
in the matching step, the matched point is determined by matching the building date of each media file to the dates of the tracking coordinates.

7. The combining method as claimed in claim 1, wherein the tracking information comprises:
a tracking information having multiple tracking coordinates; and
multiple personal media files, each of stores a building date and a building corresponding; and
in the matching step, the matched point is determined by matching the building corresponding of each media file to the tracking coordinates.

8. The combining method as claimed in claim 2, wherein the tracking information comprises:
a tracking information having multiple tracking coordinates; and
multiple personal media files, each of stores a building date and a building corresponding; and
in the matching step, the matched point is determined by matching the building corresponding of each media file to the tracking coordinates.

9. The combining method as claimed in claim 1, wherein in the matching step further comprises a providing a user interface to adjust the match points.

10. The combining method as claimed in claim 2, wherein in the matching step further comprises a providing a user interface to adjust the match points.

11. The combining method as claimed in claim 5, wherein in the matching step further comprises a providing a user interface to adjust the match points.

12. The combining method as claimed in claim 6, wherein in the matching step further comprises a providing a user interface to adjust the match points.

13. The combining method as claimed in claim 7, wherein in the matching step further comprises a providing a user interface to adjust the match points.

14. The combining method as claimed in claim 8, wherein in the matching step further comprises a providing a user interface to adjust the match points.

15. The combining method as claimed in claim 3, wherein the generating step further has an act of generating a digital map resource to show a digital map on which a route according to the tracking information is marked.

16. The combining method as claimed in claim 4, wherein the generating step further has an act of generating a digital map resource to show a digital map on which a route according to the tracking information is marked.

17. The combining method as claimed in claim 15, wherein the digital map resource is an address of a local computer in which a digital map is stored or a URL address of a web server in which a digital map.

18. The combining method as claimed in claim 16, wherein the digital map resource is an address of a local computer in which a digital map is stored or a URL address of a web server in which a digital map.
